(19) United States
(12) Patent Application Publication
(10) Pub. No.: US 2002/0128081 A1
(43) Pub. Date: Sep. 12, 2002

(54) Santa's reindeer food

(76) Inventors: George Clarke, Nanuet, NY (US); Rosanne Clarke, Nanuet, NY (US)

Correspondence Address: Karl F. Milde, Jr. Esq., MILDE, HOFFBERG & MACKLIN, L.L.P., 10 Bank Street, Suite 460, White Plains, NY, 10606, US

(21) Appl. No.: 09/804,440

(22) Filed: Mar. 12, 2001

(51) Int. Cl. A63J 5/00

(52) U.S. Cl. 472/81; 206/223

(57) ABSTRACT

A kit for supplying reindeer food to Santa's reindeer, comprising an article to be filled with a plurality of reindeer food and hoofprint maker for making hoofprints to indicate the reindeer having eaten the reindeer food. A kit for supplying food to the Easter bunny, comprising container to be filled with a plurality of food for the Easter bunny, pawprint maker indicating that the Easter bunny has visited; and bunny fur to indicate the Easter bunny has visited.

### FIELD OF THE INVENTION

This invention relates to the fields pertaining to holiday decorations, seasonal ornamentation, and decorative items. More particularly, this invention relates to a kit for supplying Santa's reindeer with food or the Easter bunny with refreshments.

### BACKGROUND OF THE INVENTION

Throughout the year, people of various cultures celebrate different religious and secular holidays to commemorate past events throughout history. One widely celebrated holiday is Christmas. People traditionally decorate their homes with lights, a nativity, and trees with ornaments and also sing carols, send holiday cards, wrap gifts, and consume specially prepared food.

Children also learn of Santa Claus, the secular figure inspired by St. Nicholas, the fourth century saint. People of many countries tell the story to their children that at Christmas time Santa Claus bringing gifts to all whom deserve them If children are good he fills their stockings with sweets, toys and trinkets, but if the children are naughty they will find coal or a bunch of switches. The image of Santa Claus as a jolly, white-haired old man complete with a sled, fur-trimmed robe, sack of toys, and reindeer is a 19^{th} century American invention. Santa Claus, with his team of reindeer is said to visit each child and climb down the chimney of their house to leave gifts in their stockings or under the Christmas tree. As time evolved, children started to leave glass of milk and platter of cookies for Santa Claus near the hearth and sometimes carrots were set out for Santa to bring to the reindeer.

Similarly, during Eastertime, the secular figure of the Easter Bunny has developed. A large white bunny called the Easter Bunny brings children baskets of small trinkets, chocolate, and candy to children while the sleep at night. Children often leave milk and carrots on a plate for the Easter Bunny before they go to sleep. When they awake, they find the Easter baskets and sometimes some rabbit fur from the Easter Bunny.

There exists a need in the marketplace for a kit having a decorative container or plate for Santa reindeer food to supply Santa's reindeer with refreshments and also kit to supply the Easter Bunny with refreshments as well The kit would be contain a number of items to enable children to offer food for Santa's reindeer on Christmas Eve and the Easter Bunny on the night before Easter Day. The kit would also contain items such as a device to make hoofprints or pawprints so that when children inspect the bowl the next morning, they will see these hoofprints or pawprints and an accompanying note that the food has been eaten.

Individual items available in the kit abound in the prior art and include decorative plates and bowls. For example, a U.S. Des. Pat. No. 168,711 to W C Richardson discloses a platter or similar article depicting an American frontier scene complete with the Pony Express, western cowboys, and horses. The patent covers a new, original and ornamental design where the dominant feature resides in the surface ornamentation of the platter or similar article Another such ornamental plate was disclosed in Des. Pat. No 38,709 to M J Mullins which portrays a woman milking a cow. A third design patent for plate or similar article is disclosed in U.S. Des. Pat. No. 161,291 to E. K. Shaw et al, which pictures a rural farming scene.

Another type of article available in the kit is a bowl or container. U.S. Pat. No. 5,209,184 to Sharkan et al teaches a pet travel bowl wherein water and/or food is available for a pet. The pet travel bowl has a container portion with an open top surrounded by a skirt portion The open top of the container portion is adapted to receive food or water with the skirt portion terminating in a ring-shaped lower edge. The pet travel bowl also includes a lid for sealingly covering the open top of the container portion and a fastener for securing the bowl to a surface to prevent any movement of the bowl on the surface. Other pet feeding dishes are disclosed in U.S. Design Pat. No. 244,216 to Gerber, U.S. Pat. No. 4,949,678 to Demko (for a disposable pet feeding dish), and U.S. Pat. No. 2,928,372 to G. F. Farley.

Additional ornamentation to articles such as lighting effects is also known in the prior art. U.S. Pat. No. 5,211,699 to Tipton discloses a lighted drinking glass, which provides an appealing illuminated effect. Light emitting diodes are positioned at the bottom of a side wall portion which contains a recessed wedge-shaped indicia Light is directed upwardly in a manner to be reflected outwardly by virtue of the angled facets of the wedge-shaped recesses. A battery for activating the diodes is positioned in a sealable compartment in the base of the glass. A mercury-type tilt switch causes the diodes to be illuminated when the glass is in the upright position, and causes the diodes to be deactivated when the glass is upside down.

While the aforementioned items are both decorative and useful, a need exists for a simple, easy to use collection of items in the form of a holiday kit to provide a decorative container or plate for Santa reindeer food to supply Santa's reindeer with refreshments and also a similar holiday kit to supply the Easter Bunny with refreshments as well.

### SUMMARY AND OBJECTS OF THE INVENTION

Accordingly, the shortcomings of the prior art are obviated by a kit for supplying reindeer food to Santa's reindeer, comprising an article to be filled with a plurality of reindeer food and hoofprint maker for making hoofprints to indicate the reindeer having eaten the reindeer food Another illustrative embodiment discloses a kit for supplying food to the Easter bunny, comprising container to be filled with a plurality of food for the Easter bunny, pawprint maker indicating that the Easter bunny has visited; and bunny fur to indicate the Easter bunny has visited.

Accordingly, it is an object of the present invention to provide a simple and easy to use holiday kit to supply Santa's reindeer with food;

It is another object of the present invention is to provide a hoofprint maker to make hoofprints in the dirt or snow to indicate that the reindeer were present,

A further object of the present invention is to provide a holiday kit to provide the Easter Bunny with food and a pawprint maker to be used to indicate the presence of the Easter Bunny;

Still another object is to provide a device to create hoofprints or pawprints in an uncomplicated manner.

Another object of the present invention to provide a holiday kit that is reliable, inexpensive to manufacture, and permits replacement of the parts, if necessary,

These and other features of the present invention are described in more detail in the following detailed description when taken with the drawings. The scope of the invention, however, is limited only by the claims appended hereto.

### BRIEF DESCRIPTION OF THE DRAWINGS

Various embodiments of the present invention are described and illustrated herein with reference to the drawings in which like items are indicated by the same reference, in which:

FIG. 1 shows one illustrative embodiment of a holiday kit;

FIG. 2 depicts a general view of a second embodiment of a Santa's holiday kit;

FIG. 3 is a perspective view of one embodiment of the article of the holiday kit in which the container has lights to illuminate it,

FIG. 4 shows one embodiment of the hoofprint maker of the Santa's holiday kit including a screw-type vice to attach the hoofprint maker to a broom handle,

FIG. 5 shows another embodiment of the hoofprint maker of the Santa's holiday kit in which the a handle is inserted into the hoofprint maker for ease in creating hoofprints;

FIG. 6 depicts another illustrative embodiment of the hoofprint maker in which a clip extending from the hoofprint maker attaches to a handle; and

FIG. 7 shows an illustrative embodiment of an Easter holiday kit in accordance with the present invention.

### DETAILED DESCRIPTION OF THE PREFERRED EMBODIMENTS

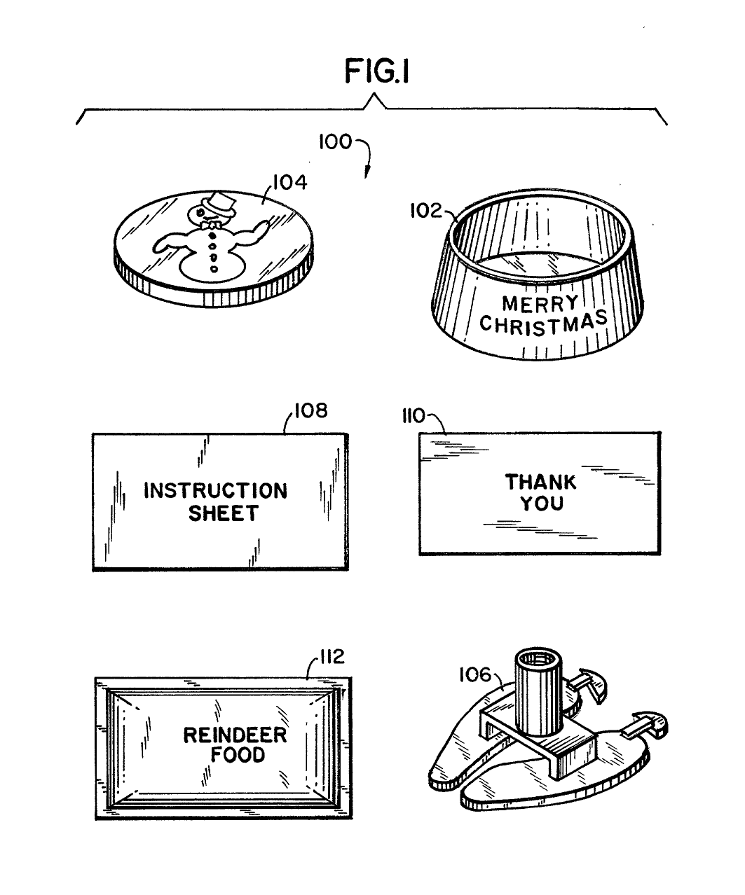

The preferred embodiments of the present invention will now be described with reference to FIGS. 1-7 of the drawings. Whenever possible, the same reference numerals are used to reference the same elements in the figures.

Turning now to FIG. 1 shows one illustrative embodiment of a holiday kit 100 which includes a article 102, lid 104, hoofprint maker 106, instruction sheet 108, personalized note 110, and reindeer food 112 The article 102 such as a container, optional lid 104, and reindeer food 112, and optionally Santa food is used by children to leave food for Santa and Santa's reindeer on Christmas Eve.

Parents use the hoofprint maker 106, instruction sheet 108 and personalized note 110 while the children are sleeping. The instruction sheet 108 explains to parents how to use the kit, particularly the hoofprint maker 106 The parents will learn how to make hoofprints in the dirt or snow with the hoofprint maker 106. Several embodiments of the hoofprint maker will be described in conjunction with FIGS. 3-6. The personalized note 110 can be a thank you note or other note left to the children from Santa and/or Santa's reindeer. Upon awakening on Christmas Day, children will ascertain that Santa and his reindeer have visited due to the presence of hoofprints and the personalized note 110, in addition to the gifts provided by Santa.

The article 102 used to hold reindeer food 112 may be a container, plate, or bowl, and may be square in shape, oval or any other shape. The article 102 may be fabricated from plastic, cardboard, melmac, or metal. The article 102 may be clear plastic or available in a variety of colors. The article 102 may have no ornamentation or may be decorated with a seasonal theme such as snowflakes, Christmas trees, children sledding, Santa Claus, and Santa's reindeer. The ornamentation may already be fabricated on the article 102. Optionally, children may decorate the article 102 using various craft items such as stickers, sparkle glue, stencils for lettering and holiday figures.

The lid 104 is placed on the container 102 and is optionally provided to protect the food from spillage during transport outdoors (if used outdoors). The lid 104 can also be pre-decorated, plain, or decorated by children. The reindeer food 112 is cheerios or other grains readily available and packaged in a clear plastic and entitled “Reindeer Food”.

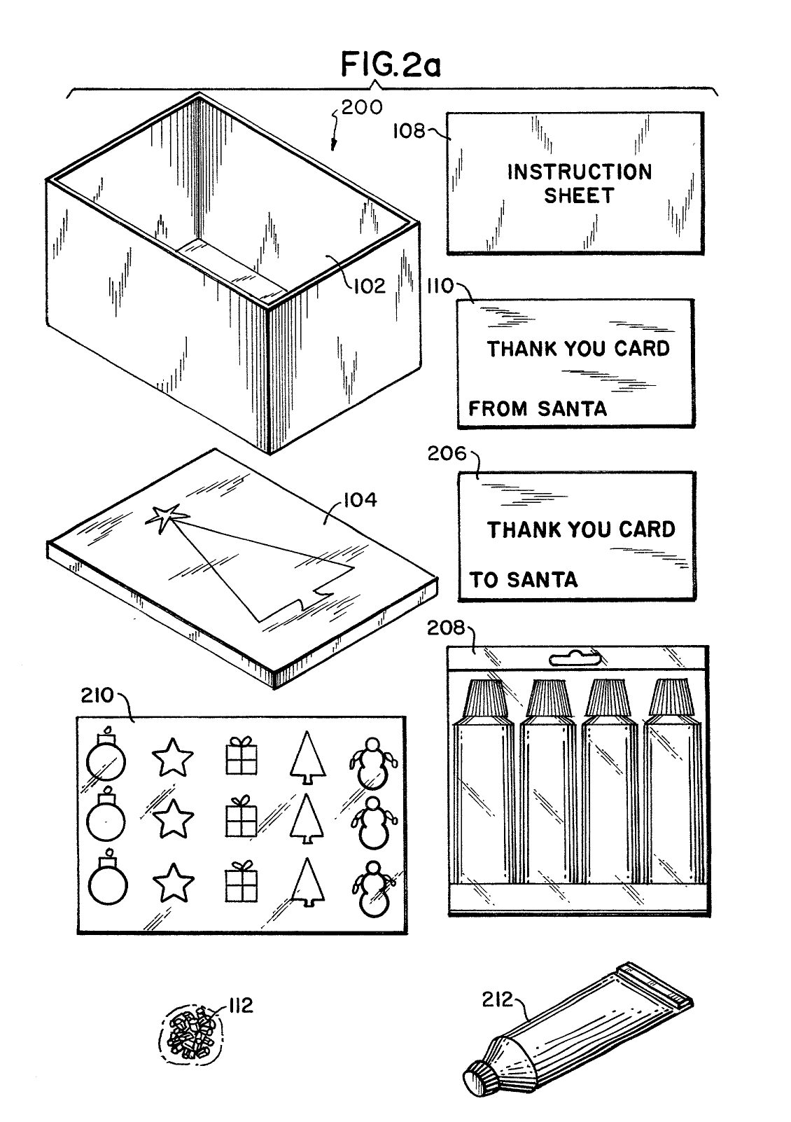

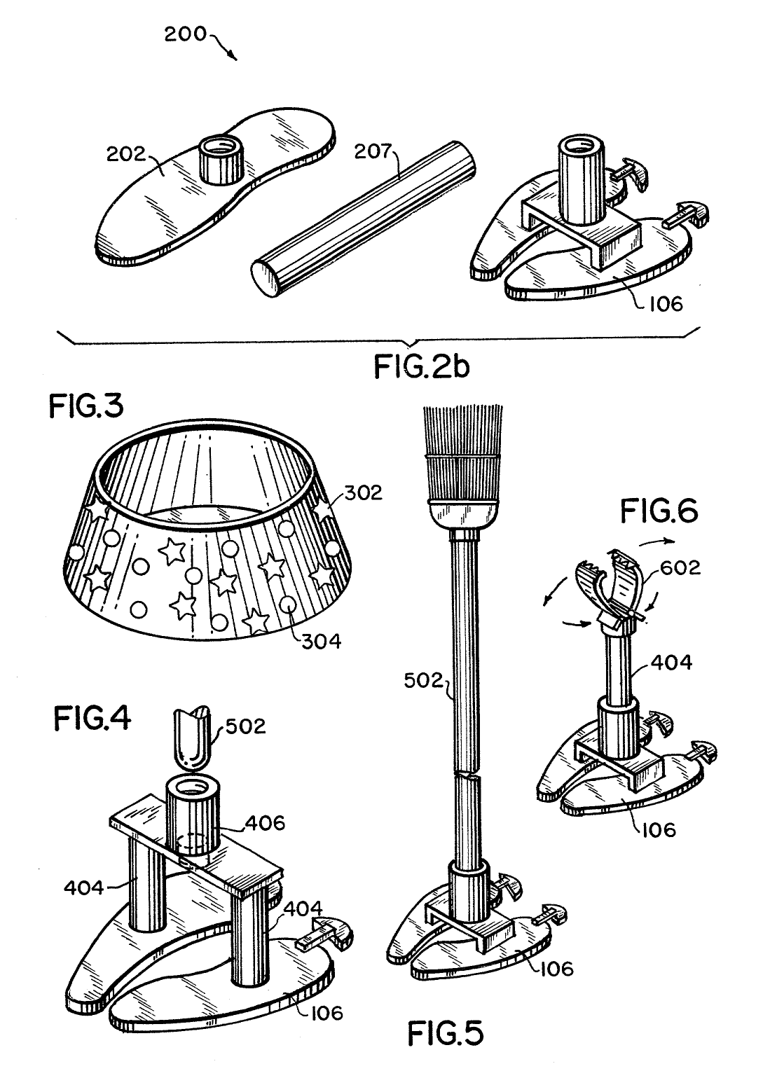

Turning now to FIG. 2, there is depicted a general view of a second embodiment of a Santa's holiday kit. The kit 200 includes a container 102, lid 104, hoofprint maker 106, bootprint maker 202, extendable rod 204, instruction sheet for the kit 108, personalized note 110 from Santa and/or Santa's reindeer, thank you note 206 to Santa and/or Santa's reindeer, reindeer food 112, colored markers 208, seasonal stickers 210, colored glitter glue 212.

In this embodiment of the kit 200, the article 102 is a container fabricated from cardboard and is easily assembled by parents and/or children. Children use the colored markers 208, seasonal stickers 210 and colored glitter glue 212 to decorate the container 102, lid 104, and create a thank you note 206 to Santa and/or Santa's reindeer It is recognized that the colored markers 208, seasonal stickers 210, and colored glitter glue 212 may be substituted with other craft items such as crayons and paint. The reindeer food 112 is placed in the article 102 before the children go to bed.

In FIG. 2, the kit 200 also includes a personalized note 110 from Santa and/or Santa's reindeer, an instruction sheet 108, and one embodiment of a hoofprint maker 106 and bootprint maker 202, both of which are used with an extendable rod 204 which is inserted in the hoofprint maker 106 or bootprint maker 202 The hoofprint maker 106 is made of molded plastic and has a circular opening extending from the top of the hoofprint maker 106. The rod 204 is snugly fitted into the hoofprint maker 106 and then the rod 204 is extended and hoofprints are made in the snow or dirt to indicate the presence of Santa's reindeer Likewise, the bootprint maker 202 is used in a similar manner in conjunction with the extendable rod 204 to create Santa's bootprints and provide evidence of Santa's visit during the night. If necessary, the hoofprint maker 106 and bootprint maker 202 may have a horizontal hole on the molded plastic to secure the rod 204 using a screw or a button available on the rod 204 which clicks into the horizontal hole when the extendable rod 204 is inserted in the circular opening on the hoofprint maker 106 or bootprint maker 202. The button is pushed in to release the rod 204 from the hoofprint maker 106 or bootprint maker 202 when it is not in use for easy storage.

Additional ornamentation to the article 102 such as lighting effects is shown in FIG. 3 which is a perspective view of one embodiment of the article 102 of the holiday kit in which the container 102 has lights to illuminate it. A plurality of openings 302 are situated in the plastic container 102. A light emitting diode (“LED”) 304 is inserted and affixed in each opening 302. The wiring and a battery for activating the diodes are positioned in a sealable compartment in the base of the container. An ON/OFF switch causes the diodes to be illuminated when the glass is in the “ON” position, and causes the diodes to be deactivated when the container is in the “OFF” position, and twinkle or alternate between an ON and OFF state when in the middle position Seasonal music can optionally be provided when the switch is in the “ON” position.

In another embodiment, there is a separate plastic base which has a battery positioned in a sealable compartment LEDs protrude from the plastic base and a clear plastic bowl 102 is placed on top of the plastic base When in the “ON” position, the lights alternate off and on and music is played.

Turning no to FIGS. 4-6, there is shown several embodiments of hoofprint maker 106 and depictions on how the hoofprint maker 106 attaches to broom handle or the optional extendable rod included in the kit. It is recognized that these concepts would apply to the bootprint maker 202.

FIG. 4 shows one embodiment of the hoofprint maker of the Santa's holiday kit including a screw-type vice to attach the hoofprint maker to a broom handle. The hoof 402 is three to four inches wide with plurality of pieces 404 protruding from it. In FIG. 4, two pieces 404 are depicted. A screw-type vice 406 screws on to the pieces 404 and screw-type vice attaches to a conventional broom handle.

FIG. 5 shows another embodiment of the hoofprint maker 106 of the Santa's holiday kit in which the handle 502 or an extendable is inserted into the hoofprint maker 106 for ease in creating hoofprints. The hoofprint maker 106 is made of molded plastic and has a circular opening extending from the top of the hoofprint maker 106 The conventional broom handle 502 or the rod 204 is snugly fitted into the hoofprint maker 106 and then the handle is used to create hoofprints in the dirt or snow Alternatively, the rod 204 is extended and hoofprints are made in the snow or dirt to indicate the presence of Santa's reindeer. Molded plastic; plastic protruding from the hoof which has an opening that is sized to snuggly fit a standard broom handle without falling off, but easily removable.

Viewing FIG. 6, there is a depiction of another illustrative embodiment of the hoofprint maker 106 in which a clip 602 extends from the hoofprint maker 106 and attaches to a conventional broom handle The clip 602 may have a plurality of circular prongs that fit around the broom handle as shown in FIG. 6, or alternatively be a two single circular pieces of molded plastic that fit around the broom handle. In another embodiment the clip 602 is a buckle that extends from the hoofprint maker 106 and buckles around the broom handle and is snapped into place.

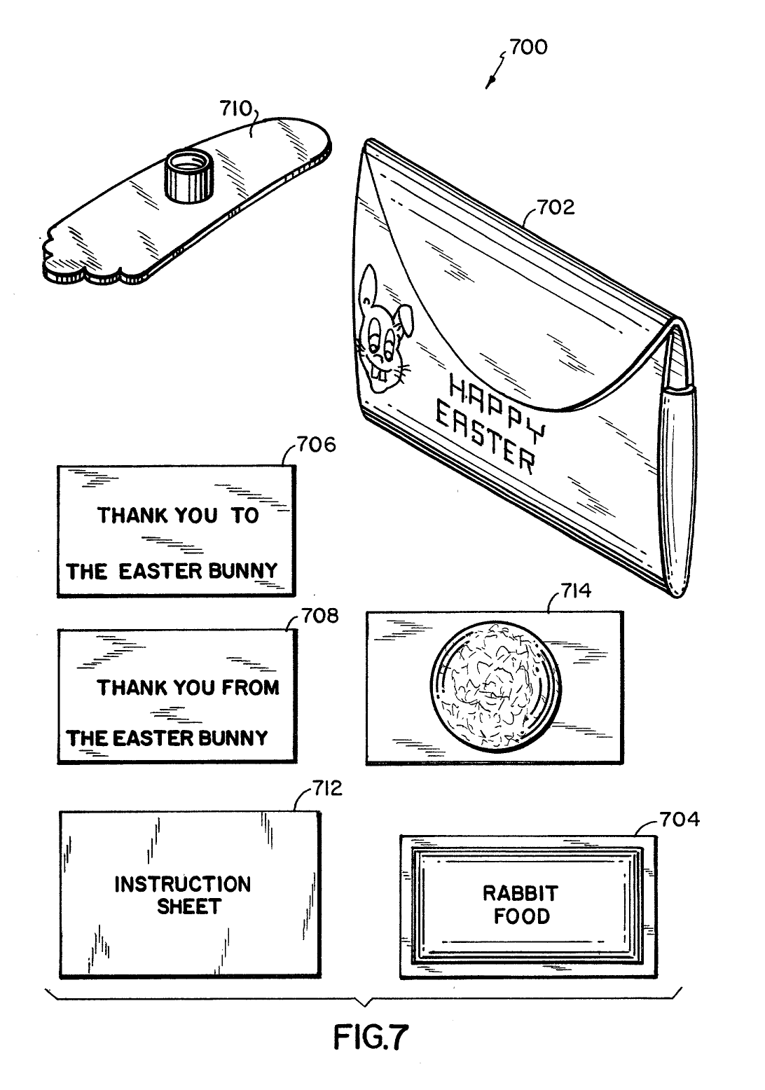

It is recognized that the concepts described in the aforementioned description could be applied to other holidays For example, FIG. 7 shows an illustrative embodiment of an Easter holiday kit in accordance with the present invention. The Easter kit 700 includes a container 702, rabbit food 704 for children to leave for the Easter bunny, Thank you note 706 to Easter bunny that may be decorated by children, personalized note 708 from the Easter bunny indicating he has visited, pawprint maker 710, instruction sheet 712 for parents, and bunny fur 714 that has been left by the Easter Bunny to indicates the Easter Bunny has visited when children awake in the morning.

From the above, it should be understood that the embodiments described, in regard to the drawings, are merely exemplary and that a person skilled in the art may make variations and modifications to the shown embodiments without departing from the spirit and scope of the invention. All such variations and modifications are intended to be included within the scope of the invention as defined by the appended claims.

What is claimed is:

1. A kit for supplying reindeer food to Santa's reindeer, comprising
(a) an article, adapted to be filled with a supply of reindeer food; and
(b) a hoofprint maker for making reindeer hoofprints on the ground to indicate the reindeer having eaten the reindeer food.

2. The kit of claim 1, further comprising an instruction sheet on how to attach the hoofprint maker to a broom handle.

3. The kit of claim 1, further comprising a brief instruction sheet on how to attach the hoofprint maker to a device.

4. The kit of claim 1, further comprising a thank you card from Santa.

5. The kit of claim 1, wherein the article is a round container.

6. The kit of claim 5, wherein the container is decorated with a seasonal item selected from a group consisting of Santa, Santa's reindeers, snowflakes, Christmas trees and illuminated lights.

7. The kit of claim 1, wherein the article is a container and, further comprising a decorated lid to cover the container.

8. The kit of claim 1, wherein the article is selected from the group consisting of a container, cookie tin, platter, and bowl.

9. A kit of claim 1, wherein the article is shaped from a group consisting of round, square, rectangular, circular, and oval.

10. A kit of claim 1, wherein the hoofprint maker comprises a member having two pieces projecting and attached to a screw type vice which affixes to a handle.

11. A kit of claim 1, further comprising reindeer food.

12. A kit for supplying reindeer food, comprising
(a) an animal feeding bowl containing reindeer food; and
(b) a hoofprint maker used to indicate that the reindeer eaten from the animal feeding bowl

13. A kit for supplying food to the Easter bunny, comprising
(a) a container to be filled with a supply of food for the Easter bunny;
(c) a pawprint maker indicating that the Easter bunny has visited and eaten the food in the container.

14. The kit of claim 13, further comprising bunny fur to indicate the Easter bunny has visited.
